(19) United States
(12) Patent Application Publication
(10) Pub. No.: US 2018/0005249 A1
(43) Pub. Date: Jan. 4, 2018

(54) OPTIMIZE A RESOURCE ALLOCATION PLAN CORRESPONDING TO A LEGACY SOFTWARE PRODUCT SUSTENANCE

(71) Applicant: HCL Technologies Limited, Noida (IN)

(72) Inventors: S U M Prasad DHANYAMRAJU, Hyderabad (IN); Satya Sai Prakash KANAKADANDI, Hyderabad (IN); Simy CHACKO, Hyderabad (IN)

(21) Appl. No.: 15/610,556

(22) Filed: May 31, 2017

(30) Foreign Application Priority Data
Jun. 30, 2016 (IN) 201611022426

(51) Int. Cl. G06Q 30/00; G06F 9/50; G06N 7/00; G06Q 50/00

(52) U.S. Cl. CPC G06Q 30/016; G06N 7/005; G06F 9/5016; G06Q 50/01

(57) ABSTRACT

The present disclosure relates to system(s) and method(s) for optimizing a resource allocation plan corresponding to a legacy software product. The system is configured to identify data pertaining to a set of entities, wherein each entity corresponds to a legacy software product. Further the system is configured to receive one or more user defined constraints, social analytics data, and historical data corresponding to each entity. Further the system is configured to analyze the historical data based on defined ontology to generate synthetic data corresponding to the set of entities. Further the system is configured to generate a simulation model to simulate the legacy software product support scenarios based on the ontology and the synthetic data. Further the system is configured to optimize the resource allocation plan based on the one or more factors, the one or more constraints and the social analytics data.

### CROSS-REFERENCE TO RELATED APPLICATIONS AND PRIORITY

The present application claims priority from Indian Patent Application No. 201611022426 filed on 30 Jun. 2016, the entirety of which is hereby incorporated by reference.

### TECHNICAL FIELD

The present disclosure in general relates to the field of resource allocation. More particularly, the present invention relates to optimizing a resource allocation plan corresponding to a legacy software product.

### BACKGROUND

Software products are widely used in day to day life and have a wide range of applications. Unlike electronic and mechanical products, software products can be upgraded from time to time in order to add new functionalities. However, with the introduction of new development languages and hardware platforms, software products also become obsolete and need to be discontinued. Practically every product has ‘retirement’ in its life cycle, be it a mechanical, electrical, electronic or software product.

Unlike many physical products which retire and get replaced as planned, software products may take more time than the estimated End Of Life (EOL) to get obsolete and replaced. Many software product companies face difficulty in extending software support, meet Service Level Agreements (SLAs) after announcing product retirement and retarded returns. However, there is no standard process to execute the retirement process effectively and efficiently. This is mainly because software products have a lot of active users at the time of software retirement. Currently, organizations adopt custom and need based solutions to address the after retirement support services and meet the adhoc demands to resolve tickets with lean undedicated teams.

Operating systems, databases, smart phones are a few for the software's and devices where even after announce retirement and make some software features obsolete, users continue to use and complain frequently. Considering the amount of users and loyalty of the users to the product, it becomes mandatory for organizations to provide the necessary support services. However, the organizations face problems which include cost, resource planning, transition and effective handling once the product is retired. Moreover, the usage trends of the retired software product is unpredictable due to unpredictable demand and issues that may arise in the retired software product.

### SUMMARY

This summary is provided to introduce aspects related to systems and methods for optimizing a resource allocation plan corresponding to a legacy software product and the aspects are further described below in the detailed description. This summary is not intended to identify essential features of the claimed subject matter nor is it intended for use in determining or limiting the scope of the claimed subject matter.

In one embodiment, a system for optimizing a resource allocation plan corresponding to a legacy software product is illustrated. The system comprises a processor coupled to a memory, wherein the processor is configured to execute programmed instructions stored in the memory. The processor may execute a programmed instruction stored in the memory to identify data pertaining to a set of entities, wherein each entity corresponds to a legacy software product. The processor may further execute a programmed instruction stored in the memory to receive one or more user defined constraints, social analytics data, and historical data corresponding to each entity. In one embodiment, the historical data may be received from a historical data repository and the social analytics data may be received from a social networking platform. The processor may further execute a programmed instruction stored in the memory to analyze the historical data based on the defined ontology to generate synthetic data corresponding to the set of entities. The synthetic data may be determined based on usage patterns corresponding to the set of entities. The processor may further execute a programmed instruction stored in the memory to generate a simulation model to simulate the legacy software product support scenarios based on the ontology and the synthetic data. The simulation model is configured to determine one or more factors affecting a resource allocation plan pertaining to the legacy software product. Further, the simulation model may be generated based on at least one simulation technique of a set of simulation techniques. The processor may further execute a programmed instruction stored in the memory to optimize the resource allocation plan based on the one or more factors, the one or more constraints and the social analytics data. In one embodiment, the resource allocation plan is optimized using at least one optimization algorithm.

In one embodiment, a method for optimizing a resource allocation plan corresponding to a legacy software product is illustrated. The method may comprise identifying data pertaining to a set of entities, wherein each entity corresponds to a legacy software product. The method may further comprise receiving one or more user defined constraints, social analytics data, and historical data corresponding to each entity. In one embodiment, the historical data may be received from a historical data repository and the social analytics data may be received from a social networking platform. The method may further comprise analyzing the historical data based on the defined ontology to generate synthetic data corresponding to the set of entities. The synthetic data may be determined based on usage patterns corresponding to the set of entities. The method may further comprise generating a simulation model to simulate the legacy software product support scenarios based on the ontology and the synthetic data. The simulation model may be configured to determine one or more factors affecting a resource allocation plan pertaining to the legacy software product. Further, the simulation model may be generated based on at least one simulation technique of a set of simulation techniques. The method may further comprise optimizing the resource allocation plan based on the one or more factors, the one or more constraints and the social analytics data. In one embodiment, the resource allocation plan is optimized using at least one optimization algorithm.

In one embodiment, a non-transitory computer readable medium embodying a program executable in a computing device for optimizing a resource allocation plan corresponding to a legacy software product is illustrated. The program comprises a program code for identifying data pertaining to a set of entities, wherein each entity corresponds to a legacy software product. The program comprises a program code for receiving one or more user defined constraints social analytics data, and historical data corresponding to each entity. In one embodiment, the historical data may be received from a historical data repository and the social analytics data may be received from a social networking platform. The program comprises a program code for analyzing the historical data based on the defined ontology to generate synthetic data corresponding to the set of entities. The synthetic data may be determined based on usage patterns corresponding to the set of entities. The program comprises a program code for generating a simulation model to simulate the legacy software product support scenarios based on the ontology and the synthetic data. The simulation model may be configured to determine one or more factors affecting a resource allocation plan pertaining to the legacy software product. Further, the simulation model may be generated based on at least one simulation technique of a set of simulation techniques. The program comprises a program code for optimizing the resource allocation plan based on the one or more factors, the one or more constraints and the social analytics data. In one embodiment, the resource allocation plan is optimized using at least one optimization algorithm.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for optimizing a resource allocation plan corresponding to a legacy software product sustenance, in accordance with an embodiment of the present subject matter.

FIG. 2 illustrates the system for optimizing a resource allocation plan corresponding to a legacy software product sustenance, in accordance with an embodiment of the present subject matter.

FIG. 3 illustrates a flow diagram for optimizing a resource allocation plan corresponding to a legacy software product sustenance, in accordance with an embodiment of the present subject matter.

FIG. 4 illustrates simulation models for simulating the legacy software product and generating the optimal resource allocation plan, in accordance with an embodiment of the present subject matter.

### DETAILED DESCRIPTION

Legacy software product leaves sufficient and legible logs throughout its life cycle starting from user deployment to usage to final termination. Deployment scenarios of various such Legacy software products and social forum discussions, email chains and phone conversations pertaining to the product, usage, problems and resolutions make a strong decipherable metadata layer over the Legacy software product.

The present disclosure relates to a system and method configured to automatically create several realistic scenarios based on the captured logs, inferred inputs and mined patterns to optimizing a resource allocation plan corresponding to a legacy software product. The system is configured to use hybrid model that embodies simulation, social analytics and historical pattern mining. The system is configured to generate precise ontology for legacy software products, encompassing several dimensions namely users, infrastructure, and business. Further, the system is configured to record information of active users, user activities, usage issues, dynamic infrastructure, product development teams and support teams. Once roles and actions are defined, the system is configured to mine all historical data to detect patterns of ticket generation, team sizing, cost benefits and Customer Satisfaction Index (CSAT)/Service Level Agreements (SLA) violations.

Further, the system enables a simulated to analyse the historical data that has various distributions and key relationships embodied. This simulator is configured to generate various realistic and synthetic outputs related to cost, SLA violations/penalties, Turnaround Time (TAT) and team requirements based on peak/bursty loads, random failures and abrupt changes. In one embodiment, Standard Monte Carlo simulation technique, Markov models, and other custom simulation methods may be enabled by the system in order to analyse the historical data. The system is configured to map ontology and historical data mining insights to generate simulation results for prediction and forecast of issues, impact, team sizing, Service Level Agreement (SLA) violations in advance.

While aspects of described system and method for optimizing a resource allocation plan corresponding to a legacy software product may be implemented in any number of different computing systems, environments, and/or configurations, the embodiments are described in the context of the following exemplary system.

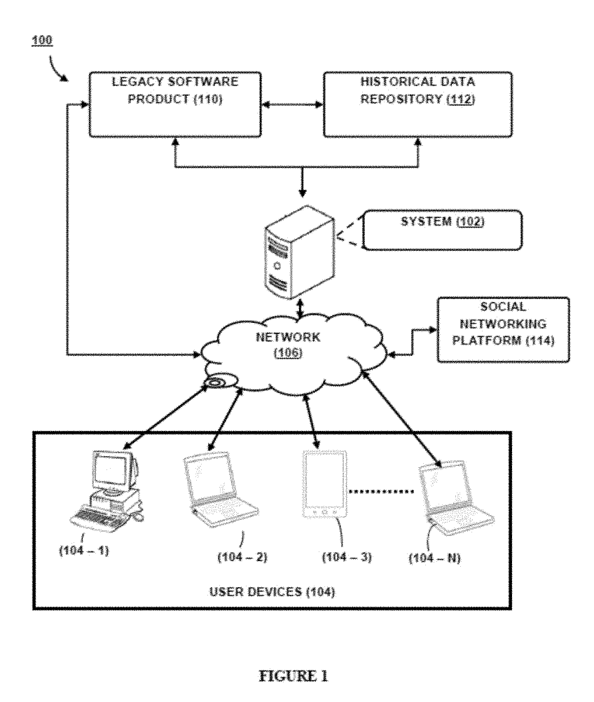

Referring now to FIG. 1, a network implementation 100 of a system 102 for optimizing a resource allocation plan corresponding to a legacy software product is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by a primary user through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation, file server, version control servers, bugs tracking servers. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

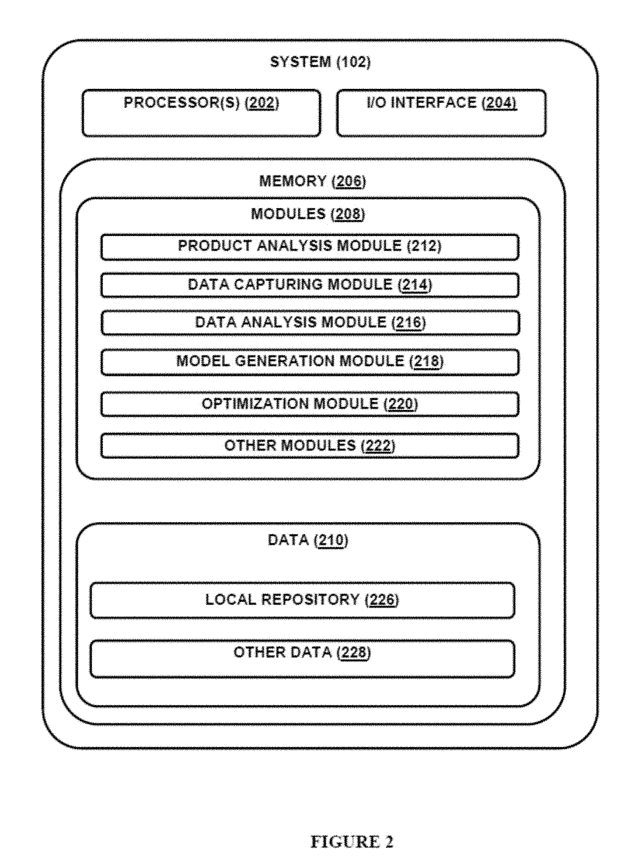

Further, the system 102 is configured to connect with a legacy software product 110 and a historical data repository 112. The system 102 is configured to identify data pertaining to a set of entities, wherein each entity corresponds to a legacy software product 110. The historical data repository 112 is configured to store historical data associated with the legacy software product 110. The system 102 may access the historical data repository 112 and capture the historical data. Once the historical data is captured, the system may capture user defined constraints from user devices 104 connected to the system 102 through network 106. Further, the system 102 may capture social analytics data a social networking platform 114 connected to the network 106. The system 102 may analyze the historical data based on defined ontology to generate synthetic data corresponding to the set of entities. The synthetic data may be determined based on usage patterns corresponding to the set of entities. Further, the system may generate a simulation model to simulate the legacy software product support scenarios based on the ontology and the synthetic data. The simulation model may be configured to determine one or more factors affecting a resource allocation plan pertaining to the legacy software product. Further, the simulation model may be generated based on at least one simulation technique of a set of simulation techniques. The system 102 may further optimize the resource allocation plan based on the one or more factors, the one or more constraints and the social analytics data. In one embodiment, the resource allocation plan is optimized using at least one optimization algorithm. The process of optimizing a resource allocation plan corresponding to a legacy software product is further elaborated with respect to FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a product analysis module 212, a data capturing module 214, a data analysis module 216, a model generation module 218, an optimization module 220, and other modules 222. The other modules 222 may include programs or coded instructions that supplement applications and functions of the system 102. The data 210, amongst other things, serves as a repository for storing data processed, received, and generated by one or more of the modules 208. The data 210 may also include a local repository 226, and other data 228. The local repository 226 is configured to store data received from legacy software products 110, historical data repository 112 and social networking platform 114.

In one embodiment, the product analysis module 212 is configured to identify data pertaining to a set of entities corresponds to the legacy software product 110. The set of entities may include tickets, Human Resource (HR) allocation, customer, usage trends, testing cycle, standard metrics, and resource grading. The set of entities corresponding to the legacy software product 110 may be determined based on the application of the legacy software product 110.

Once the data corresponding to the set of entities is extracted, in the next step, the data capturing module 214 is configured to receive one or more user defined constraints, social analytics data, and historical data corresponding to each entity. In one embodiment, the historical data may be received from a historical data repository 112. In one embodiment, the historical data is associated with the usage pattern of the legacy software product 110. Further, the social analytics data may be received from the social networking platform 114, whereas the user defined constraints may be captured from the user devices 104. The social analytics data may correspond to user reviews, user feedback, blogs, and posts describing the legacy software product 110 in detail. Further, the user defined constraints may be parameters such as maximum number of resources, memory allocation, or any other criteria defined by stakeholder of the legacy software product 110 for provisioning support services to the legacy software product 110 after announcing retirement.

Further, the data analysis module 216 is configured to analyze the historical data based on defined ontology to generate synthetic data corresponding to the set of entities. The synthetic data may be determined based on usage patterns corresponding to the set of entities. The ontology of the legacy software product 110 indicates interdependency of the different entities associated with the legacy software product 110. For example, the tickets generated for the legacy software product 110 may be directly proportional to the testing cycle or the human resources allocated may be directly proportional to the turnaround time. Further, the synthetic data is derived from usage patterns corresponding to the entities. For example, the synthetic data may correspond to information associated with the number of resources that are allocated for the legacy software product 110, the memory and processing power required by the legacy software product 110, the active users of the legacy software product 110, the customers of the legacy software product 110 and the like.

Once the ontology and synthetic data corresponding to the set of entities is captured, in the next step, the model generation module 218 is configured to generate a simulation model to simulate the legacy software product support scenarios based on the ontology and the synthetic data. In one embodiment, simulation model is configured to accept the synthetic data generated based on the historical data, user constraints and other cost related inputs provided by the user for simulating the legacy software product. Further, the simulation is configured to simulate the execution of the tasks which may include addressing customer tickets using the industry standard or project specific metrics.

The simulation model is configured to determine one or more factors affecting a resource allocation plan pertaining to the legacy software product. The simulation model is configured to simulate the future usage trends, extend support, meet Service Level Agreements (SLAs) and predict possible issues in the legacy software product. Further, the one or more factors may include cost, Service Level Agreements (SLA) violations and penalties, a Turn Around Time (TAT), and team requirements based on peak load, bursty load, random failures and abrupt changes. Further, the simulation model may be generated by the model generation module 218 based on at least one simulation technique of a set of simulation techniques. Further, the model generation module 218 may use the set of simulation techniques include Standard Monte Carlo simulation technique, Markov models, and custom simulation methods for generating the simulation model.

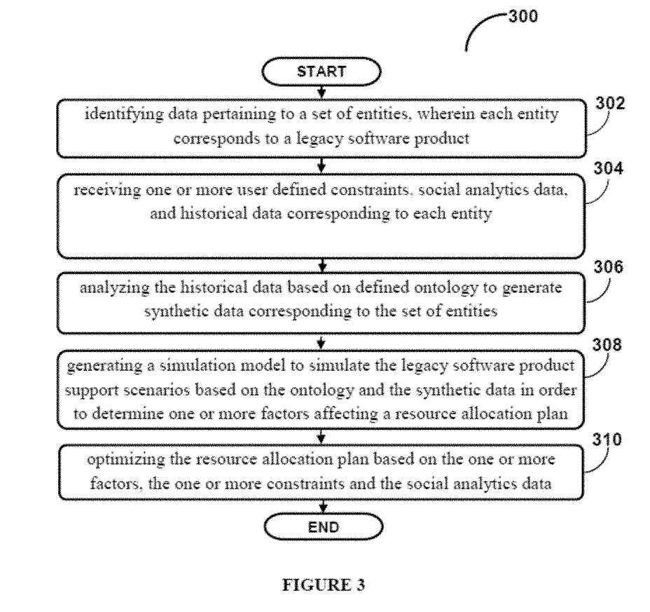

Further, the optimization module 220 may further execute a programmed instruction stored in the memory to optimize the resource allocation plan based on the one or more factors, the one or more constraints, and the social analytics data. In one embodiment, the resource allocation plan is optimized using at least one optimization algorithm. In one embodiment, the optimization algorithm may be based on statistical analysis. The purpose of the optimization is to compute the minimum resources (cost/human/row-material) required to provide support services for the maintenance of the legacy software product. In one embodiment, the optimization may be performed using optimization algorithms such as greedy algorithm and/or constraint satisfaction algorithm. The method for optimizing a resource allocation plan corresponding to a legacy software product is further illustrated with respect to the block diagram of FIG. 3.

Referring now to FIG. 3, a method 300 for optimizing a resource allocation plan corresponding to a legacy software product is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the product analysis module 212 is configured to identify data pertaining to a set of entities corresponds to the legacy software product 110. The set of entities may include tickets, Human Resource (HR) allocation, customer, usage trends, testing cycle, standard metrics, and resource grading. The set of entities corresponding to the legacy software product 110 may be determined based on the application of the legacy software product 110.

At block 304, the data capturing module 214 is configured to receive one or more user defined constraints, social analytics data, and historical data corresponding to each entity. In one embodiment, the historical data may be received from a historical data repository 112. In one embodiment, the historical data is associated with the usage pattern of the legacy software product 110. Further, the social analytics data may be received from the social networking platform 114, whereas the user defined constraints may be captured from the user devices 104. The social analytics data may correspond to user reviews, user feedback, blogs, and posts describing the legacy software product 110 in detail. Further, the user defined constraints may be parameters such as maximum number of resources, memory allocation, or any other criteria defined by stakeholder of the legacy software product 110 for provisioning support services to the legacy software product 110 after announcing retirement.

At block 306, the data analysis module 216 is configured to analyze the historical data based on the defined ontology to generate synthetic data corresponding to the set of entities. The synthetic data may be determined based on usage patterns corresponding to the set of entities. The ontology of the legacy software product 110 indicates interdependency of the different entities associated with the legacy software product 110. For example, the tickets generated for the legacy software product 110 may be directly proportional to the testing cycle or the human resources allocated may be directly proportional to the turnaround time. Further, the synthetic data is derived from usage patterns corresponding to the entities. For example, the synthetic data may correspond to information associated with the number of resources that are allocated for the legacy software product 110, the memory and processing power required by the legacy software product 110, the active users of the legacy software product 110, the customers of the legacy software product 110 and the like.

At block 308, the model generation module 218 is configured to generate a simulation model to simulate the legacy software product support scenarios based on the ontology and the synthetic data. The simulation model is configured to determine one or more factors affecting a resource allocation plan pertaining to the legacy software product. The simulation model is configured to simulate the future usage trends, extend support, meet Service Level Agreements (SLAs) and predict possible issues in the legacy software product. Further, the one or more factors may include cost, Service Level Agreements (SLA) violations and penalties, a Turn Around Time (TAT), and team requirements based on peak load, bursty load, random failures and abrupt changes. Further, the simulation model may be generated by the model generation module 218 based on at least one simulation technique of a set of simulation techniques. Further, the model generation module 218 may use the set of simulation techniques include Standard Monte Carlo simulation technique, Markov models, and custom simulation methods for generating the simulation model.

At block 310, the optimization module 220 may further execute a programmed instruction stored in the memory to optimize the resource allocation plan based on the one or more factors, the one or more constraints, and the social analytics data. In one embodiment, the resource allocation plan is optimized using at least one optimization algorithm. In one embodiment, the optimization algorithm may be based on statistical analysis.

### Working Example

In one example, the system 102 is configured to analyze a legacy software product for generating the resource allocation plan. Further, the system 102 enables a plurality of users of the system to gather historical data corresponding to the product. The users may gather all the historical data related to tickets, users patterns, sales, usage, social media discussion. Further, the system 102 is configured to accept user inputs from the stakeholders of the legacy software product. Further, the system 102 is configured to extract different metrics such as max, min and average time taken for executing different tasks, task patents, trend, randomness, its correlation with time and other attributes. In one embodiment, the system 102 may accept user inputs on how long the product is to be sustained, available resources, skills and capabilities, other metrics such as attrition & rotation rate, on boarding time and the like.

Once the historical data and product related information is accepted, the system 102 is configured to generate the synthetic data that could probably occur for next ‘n’ years. Further, the system 102 may generate a simulation model based on the ontology (parameter correlations) and synthetic data. The simulation model may be used to predict usage pattern for the next ‘n’ years and come out with possible risks such as SLA violations, CSAT impact, and other recommendations such as how the team members should be assigned to different types of tasks, re-skilling requirement etc. The simulation model may be used to repeat the prediction and come up with the optimal solution.

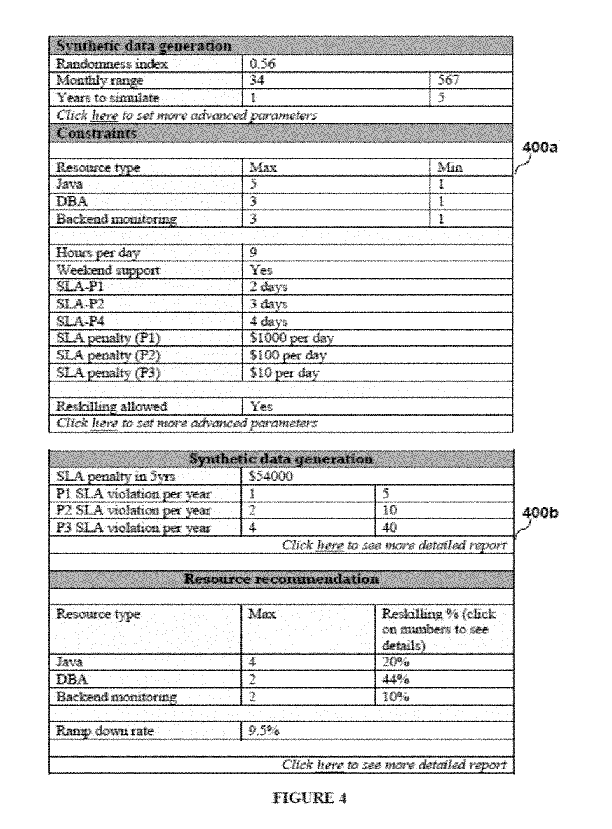

FIG. 4 represents the simulation models 400a and 400b used for simulating the legacy software product and generating the optimal resource allocation plan.

Although implementations for methods and systems for optimizing a resource allocation plan corresponding to a legacy software product has been described, it is to be understood that the appended claims are not necessarily limited to the specific features or methods described. Rather, the specific features and methods are disclosed as examples of implementations for optimizing a resource allocation plan corresponding to a legacy software product.

We claim:

1. A method for optimizing a resource allocation plan corresponding to a legacy software product, the method comprising:
identifying, by a processor, data pertaining to a set of entities, wherein each entity corresponds to a legacy software product;
receiving, by the processor, one or more user defined constraints social analytics data, and historical data corresponding to each entity, wherein the historical data is received from a historical data repository, and wherein the social analytics data is received from a social networking platform;
analyzing, by the processor, the historical data based on defined ontology to generate synthetic data corresponding to the set of entities, wherein the synthetic data is determined based on usage patterns corresponding to the set of entities;
generating, by a processor, a simulation model to simulate the legacy software product support scenarios based on the ontology and the synthetic data in order to determine one or more factors affecting a resource allocation plan pertaining to the legacy software product, wherein the simulation model is generated based on at least one simulation technique of a set of simulation techniques; and
optimizing, by the processor, the resource allocation plan based on the one or more factors, the one or more constraints and the social analytics data, wherein the resource allocation plan is optimized using at least one optimization algorithm.

2. The method of claim 1, wherein the set of elements comprise tickets, Human Resource (HR) allocation, customer, usage trends, testing cycle, standard metrics, and resource grading.

3. The method of claim 1, wherein the simulation model is configured to simulate the future usage trends, extend support, meet Service Level Agreements (SLAs) and predict possible issues in the legacy software product.

4. The method of claim 1, wherein the one or more factors include cost, Service Level Agreements (SLA) violations and penalties, a Turn Around Time (TAT), and team requirements based on peak load, bursty load, random failures and abrupt changes.

5. The method of claim 1, wherein the set of simulation techniques include Standard Monte Carlo simulation technique, Markov models, and custom simulation methods.

6. The method of claim 1, wherein the optimization algorithm is based on statistical analysis, and wherein the optimization algorithms include greedy algorithm and/or constraint satisfaction algorithm.

7. A system for optimizing a resource allocation plan corresponding to a legacy software product, the system comprising:
a memory;
a processor coupled to the memory, wherein the processor is configured to execute programmed instructions stored in the memory for:
identifying data pertaining to a set of entities, wherein each entity corresponds to a legacy software product;
receiving one or more user defined constraints, social analytics data, and historical data corresponding to each entity, wherein the historical data is received from a historical data repository, and wherein the social analytics data is received from a social networking platform;
analyzing the historical data based on defined ontology to generate synthetic data corresponding to the set of entities, wherein the synthetic data is determined based on usage patterns corresponding to the set of entities;
generating a simulation model to simulate the legacy software product support scenarios based on the ontology and the synthetic data in order to determine one or more factors affecting a resource allocation plan pertaining to the legacy software product, wherein the simulation model is generated based on at least one simulation technique of a set of simulation techniques; and
optimizing the resource allocation plan based on the one or more factors, the one or more constraints and the social analytics data, wherein the resource allocation plan is optimized using at least one optimization algorithm.

8. The system of claim 7, wherein the set of elements comprise tickets, Human Resource (HR) allocation, customer, usage trends, testing cycle, standard metrics, and resource grading.

9. The system of claim 7, wherein the simulation model is configured to simulate the future usage trends, extend support, meet Service Level Agreements (SLAs) and predict possible issues in the legacy software product.

10. The system of claim 7, wherein the one or more factors include cost, Service Level Agreements (SLA) violations and penalties, a Turn Around Time (TAT), and team requirements based on peak load, bursty load, random failures and abrupt changes.

11. The system of claim 7, wherein the set of simulation techniques include Standard Monte Carlo simulation technique, Markov models, and custom simulation methods.

12. The system of claim 7, wherein the optimization algorithm is based on statistical analysis, and wherein the optimization algorithms include greedy algorithm and/or constraint satisfaction algorithm.

13. A non-transitory computer readable medium embodying a program executable in a computing device for optimizing a resource allocation plan corresponding to a legacy software product, the computer program product comprising:
a program code for identifying data pertaining to a set of entities, wherein each entity corresponds to a legacy software product;
a program code for receiving one or more user defined constraints social analytics data, and historical data corresponding to each entity, wherein the historical data is received from a historical data repository, and wherein the social analytics data is received from a social networking platform;
a program code for analyzing the historical data based on defined ontology to generate synthetic data corresponding to the set of entities, wherein the synthetic data is determined based on usage patterns corresponding to the set of entities;
a program code for generating a simulation model to simulate the legacy software product support scenarios based on the ontology and the synthetic data in order to determine one or more factors affecting a resource allocation plan pertaining to the legacy software product, wherein the simulation model is generated based on at least one simulation technique of a set of simulation techniques; and
a program code for optimizing the resource allocation plan based on the one or more factors, the one or more constraints and the social analytics data, wherein the resource allocation plan is optimized using at least one optimization algorithm.
